(19) United States
(12) Patent Application Publication
(10) Pub. No.: US 2023/0247452 A1
(43) Pub. Date: Aug. 3, 2023

(54) SYSTEMS AND METHODS FOR NEW RADIO (NR) CELL ADDITION MEASUREMENT

(71) Applicant: APPLE INC., Cupertino, CA (US)

(72) Inventors: Sriram Subramanian, Cupertino, CA (US); Dirk Nickisch, Oberpframmern (DE); Madhukar K. Shanbhag, Cupertino, CA (US); Sanjeevi Balasubramanian, Cupertino, CA (US); Sharad Sambhwani, San Diego, CA (US); Shiva Krishna Narra, Cupertino, CA (US); Vishwanth Kamala Govindaraju, Mountain View, CA (US)

(21) Appl. No.: 18/065,848

(22) Filed: Dec. 14, 2022

Related U.S. Application Data
(60) Provisional application No. 63/267,239, filed on Jan. 28, 2022.

(51) Int. Cl. H04W 24/08; H04B 17/318; H04B 17/336

(52) U.S. Cl. CPC H04W 24/08; H04B 17/318; H04B 17/336

(57) ABSTRACT

Systems and methods are provided for a user equipment (UE) connected to a network using FR1 and configured for mmWave beam measurement to communicate using FR2. The UE receives, from a base station, measurement configuration information including an indication of measurement opportunities. The UE determines that a current data traffic type is associated with mmWave communication. In response to the current data traffic type being associated with the mmWave communication, the UE performs an FR2 cell addition measurement decision. The FR2 cell addition measurement decision may be based on one or more of signal quality feedback, sensor input, UE motion state, and geographic (geo) location information associated with FR2 cell information. Based on the FR2 cell addition measurement decision, the UE suppresses or selects a next measurement opportunity of the measurement opportunities for measuring one or more mmWave signals.

### TECHNICAL FIELD

This application relates generally to wireless communication systems, including cell measurements for link addition.

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a or g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

Frequency bands for 5G NR may be separated into two or more different frequency ranges. For example, Frequency Range 1 (FR1) may include frequency bands operating in sub-6 GHz frequencies, some of which are bands that may be used by previous standards, and may potentially be extended to cover new spectrum offerings from 410 MHz to 7125 MHz. Frequency Range 2 (FR2) may include frequency bands from 24.25 GHz to 52.6 GHz. Note that in some systems, FR2 may also include frequency bands from 52.6 GHz to 71 GHz (or beyond). Bands in the millimeter wave (mmWave) range of FR2 may have smaller coverage but potentially higher available bandwidth than bands in FR1. Skilled persons will recognize these frequency ranges, which are provided by way of example, may change from time to time or from region to region.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a block diagram illustrating an example non-standalone architecture in accordance with one embodiment.

FIG. 2 is a block diagram illustrating an example architecture for a measurement process by a UE for FR2 NR addition in accordance with one embodiment.

FIG. 3 is a block diagram illustrating an example measurement process for FR2 NR addition in accordance with one embodiment.

FIG. 4 is a flowchart of a method for NR addition measurement in accordance with one embodiment.

FIG. 5 is a flowchart of a method for determining a UE defined addition threshold for NR addition in accordance with one embodiment.

FIG. 6 is a flowchart of a method for NR addition measurement in accordance with one embodiment.

FIG. 7 illustrates an example architecture of a wireless communication system, according to embodiments disclosed herein.

FIG. 8 illustrates a system for performing signaling between a wireless device and a network device, according to embodiments disclosed herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component.

When a UE searches for power of signals transmitted by FR2 cells, the UE activates mmWave circuitry with beam management. The process of adding an FR2 cell (i.e., NR addition) includes a synchronization signal block (SSB) based measurement, wherein data flows on channel state information (CSI) beams, which typically use eight to ten decibels (dB) of additional gain. The 3GPP standard leaves the frequency of search (i.e., how often the UE searches for FR2 signals) to UE implementation. Thus, a UE may use a proprietary algorithm to back off search and measurements when a cell is not detected during a prior search. Without an optimal algorithm, however, the UE may spend a significant amount of power in triggering beam management (BM) and FR2 modules when there are no FR2 cell signals to measure.

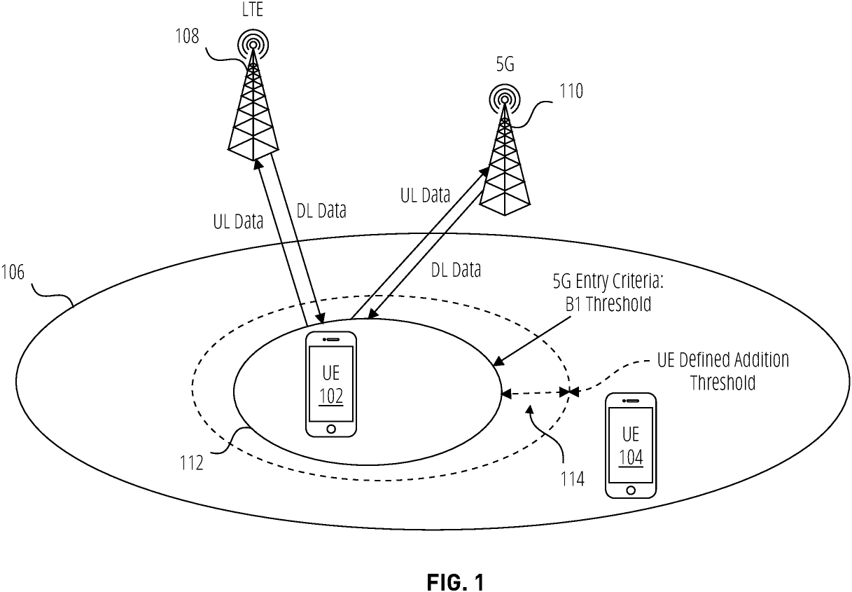

For example, FIG. 1 is a block diagram illustrating an example non-standalone architecture according to one embodiment. Although discussed with respect to a non-standalone architecture, skilled persons will recognize from the disclosure herein that other architectures may also be used. For example, the embodiments disclosed herein may also apply to a standalone architecture in which NR FR1 signals are communicated through a primary cell and NR FR2 signals are communicated through a secondary cell.

In the example shown in FIG. 1, a first UE 102 and a second UE 104 are within an LTE coverage area 106 provided by an eNB 108. The first UE 102 is also within an FR2 coverage area 112 provided by a gNB 110. However, the second UE 104 is outside the FR2 coverage area 112. Thus, both the first UE 102 and the second UE 104 may communicate uplink (UL) and downlink (DL) data with the eNB 108, whereas only the first UE 102 communicates UL and DL data with the gNB 110. The gNB 110 may be configured to periodically transmit SSB in FR2 (e.g., every 20 milliseconds (ms)) and the second UE 104 may be configured to attempt to periodically measure the SSB signals from the gNB 110.

The first UE 102 is within the FR2 coverage area 112 where measurements of the SSB exceed a predetermined threshold. The predetermined threshold may be referred to as a B1 threshold, a radio resource control (RRC) threshold or an RRC defined threshold (i.e., threshold is provided by the network to the UEs using RRC signaling). Similarly, if the second UE 104 enters the FR2 coverage area 112 where measurements of the SSB exceed the predetermined threshold, then a 5G entry criteria may be met wherein the second UE 104 may attempt to connect to the 5G network to communicate UL and DL data through the gNB 110 using FR2. However, until the second UE 104 nears or enters the FR2 coverage area 112, the second UE 104 may needlessly use power and resources searching for the SSB signals from the gNB 110 (e.g., every 20 ms).

Thus, certain embodiments disclosed herein use a UE defined addition threshold that comprises the RRC defined threshold plus a hysteresis value. The hysteresis value may be determined by the UE based on an average of past measurements or may be provided to the UE via RRC signaling. When the second UE 104 moves into the area 114 where it measures an SSB that is greater than the UE defined addition threshold, the second UE 104 increases the number of SSB measurements over a period of time (i.e., the periodicity of SSB measurements) so it can more quickly detect when the 5G entry criteria is met as it enters the FR2 coverage area 112. For example, if the network sets a B1 threshold using RRC signaling at -105 dBm, the UE may determine an internal checkpoint when it measures -110 dBm (5 dB hysteresis) at which to start additional processes as it gets close to the network B1 threshold. The network B1 threshold is not constant. Thus, based on configurations set by the network, the UE may add the hysteresis value to the current B1 threshold to start a more beam aggressive beam measurement process.

On the other hand, when the first UE 102 or the second UE 104 moves away from the FR2 coverage area 112 and leaves the area 114, the measured SSB becomes less than the UE defined addition threshold and the UE reduces the periodicity of SSB measurements to conserve processing resources and power.

In certain embodiments, the decision of when and/or how often to search for FR2 cells is based on parameters including signal quality from past measurements, type of data traffic to send/receive, sensor inputs to determine UE location (e.g., indoor/outdoor) where FR2 is available, the UE’s motion state, and/or geographic (geo) locations tagged with FR2 cells.

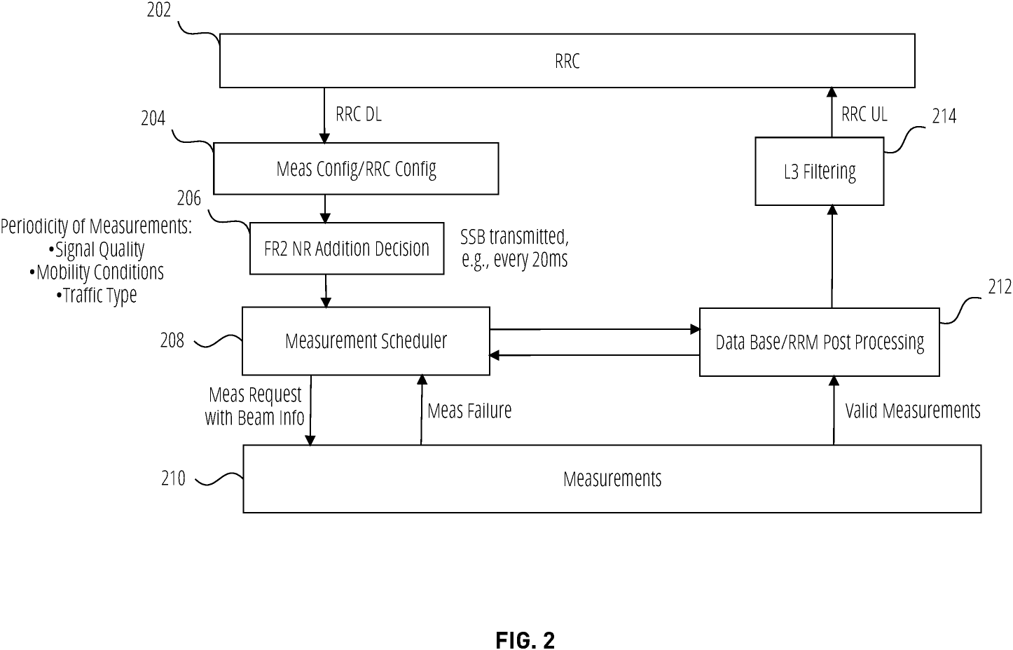

FIG. 2 is a block diagram illustrating an example architecture for a measurement process by a UE for FR2 NR addition according to one embodiment. In the illustrated example, an RRC layer 202 processes an RRC DL message. The RRC DL message may include configuration information 204 such as a measurement configuration and/or an RRC configuration. The measurement configuration may configure the UE to measure SSB transmitted from a gNB using frequencies in FR2. The measurement configuration and/or the RRC configuration may indicate measurement opportunities (e.g., the gNB transmits SSB every 20 ms). The measurement configuration may also be referred to as a report configuration or measurement report configuration.

Based on the measurement configuration and/or the RRC configuration, the UE performs an FR2 NR addition decision procedure 206 to determine a periodicity of measurements or whether to perform or suppress measurement of a next SSB. As disclosed herein, the FR2 NR addition decision procedure 206 may be based, at least in part, on signal quality, mobility conditions, and/or traffic type. An output of the FR2 NR addition decision procedure 206 includes a request that a measurement scheduler 208 either performs a measurement at the next SSB measurement opportunity or does not perform (i.e., suppresses) the measurement at the next SSB measurement opportunity. Thus, the UE conserves power and processing resources by not attempting to measure and report at every SSB measurement opportunity.

If a measurement is to be performed at the next SSB measurement opportunity, the measurement scheduler 208 sends a measurement request with beam information to a measurement module 210. The measurement module 210 performs the SSB measurements in FR2 and either reports to the measurement scheduler 208 that the measurements failed or sends valid measurements to a data base and/or radio resource management (RRM) post processing module 212. The measurements may then be passed through layer 3 (L3) filtering 214 before being provided to the RRC layer 202 using RRC UL message.

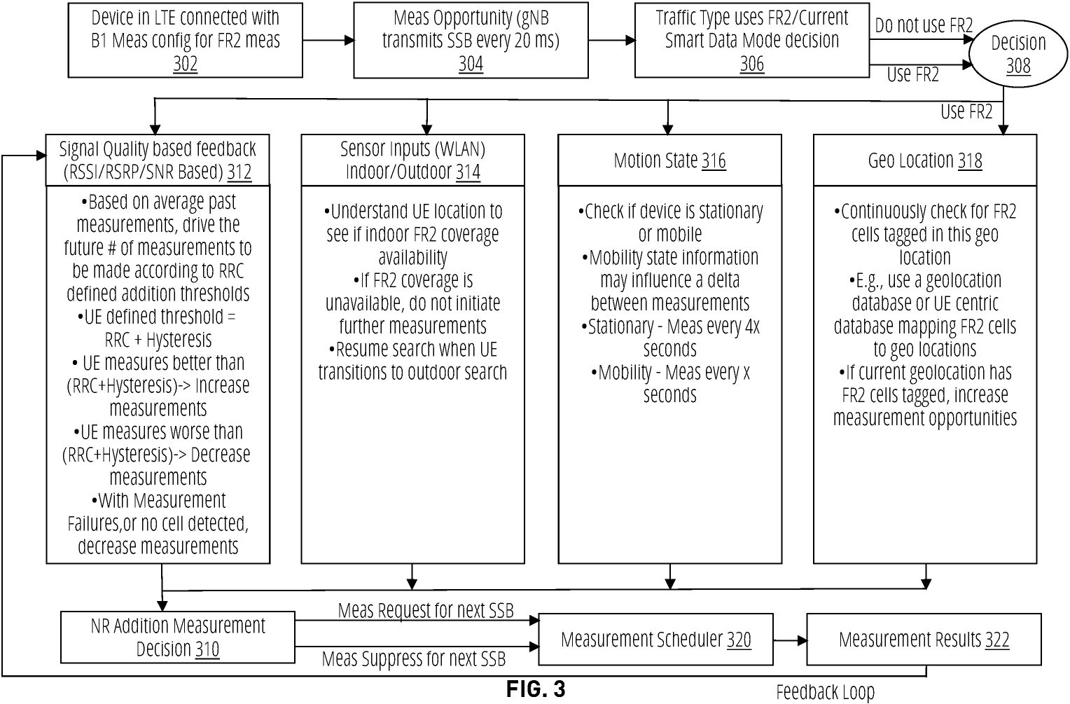

FIG. 3 is a block diagram illustrating an example measurement process for FR2 NR addition according to one embodiment. The illustrated measurement process begins with a device 302 (e.g., UE) in LTE connected mode with a B1 threshold measurement configuration for FR2 measurement. Based on a measurement opportunity 304 and a traffic type 306, the device makes a decision 308 to either use FR2 (if available) or to not use FR2. The measurement opportunity 304 may be configured by RRC signaling and may be based on the periodicity of SSB signals transmitted by the base station (e.g., a gNB may transmit SSB every 20 ms). The traffic type 306 may include a list of types of traffic or applications that prefer or require the use of FR2 (e.g., enhanced mobile broadband (eMBB) and/or ultra-reliable low latency communications (uRLLC) such as for autonomous driving, emergency services, robotic surgery, factory automation, etc.). In certain embodiments, the decision 308 may also be based on a current smart data mode decision in which the device intelligently switches between LTE and 5G based on network availability and/or UE power requirements.

When the decision 308 is to use FR2 (i.e., measurement opportunities are available and FR2 is preferred or required), then the UE performs an NR addition measurement decision 310 based on one or more of signal quality based feedback 312, sensor inputs 314, motion state 316, and geo location 318.

The signal quality based feedback 312 may be based on one or more of received signal strength indicator (RSSI), reference signal received power (RSRP), and signal-to-noise ratio (SNR) measurements. However, persons skilled in the art will recognize from the disclosure herein that other measurement values may also be used such as reference signal received quality (RSRQ) or signal to interference and noise ratio (SINR). Based on average of past measurements, the UE drives or determines the future number of measurements to be made during a period of time according to RRC defined addition thresholds. A UE defined addition threshold used for NR addition may comprise the RRC defined threshold plus hysteresis. A hysteresis value may be determined by the UE based on the average past measurements or may be provided to the UE via RRC signaling. When the UE measures an SSB better than (i.e., a measured value greater than) the RRC threshold value plus the hysteresis value, the UE increases the number of SSB measurements over a period of time. On the other hand, when the UE measures an SSB worse than (i.e., a measured value less than) the RRC threshold value plus the hysteresis value, the UE decreases the number of SSB measurements over a period of time (e.g., skips one or more of the measurement opportunities). In certain embodiments, when there is a measurement failure, or when no cell is detected, the UE decreases the number of SSB measurements over a period of time.

The sensor inputs 314 may include wireless local area network (WLAN), e.g., Wi-FiⒸ, inputs to determine whether the UE is indoor or outdoor. If indoor, the UE may also use the sensor inputs to determine whether indoor FR2 coverage is available. If indoor FR2 coverage is available, the UE may maintain or increase the number of SSB measurements over a period of time. If indoor FR2 is unavailable, however, the UE does not initiate further SSB measurements. The UE may then resume searching for FR2 cells when the UE transitions to outdoors (e.g., as determined by the sensor inputs).

When using the motion state 316 as an input to the NR addition measurement decision 310, the UE determines whether it is stationary or mobile. Mobility state information, which may include a speed of the UE, may influence a delta between measurements. For example, when the UE is stationary the UE may measure SSB every 4x seconds, and when the UE is mobile the UE may measure SSB every x seconds. Further, if the UE is moving relatively slowly (e.g., the user is walking as compared to driving), the UE may measure SSB every 3x seconds.

When using the geo location 318 as an input to the NR addition measurement decision 310, the UE may frequently or continuously check a list or database for FR2 cells tagged for a current geo location. For example, the UE may use a geolocation database or UE centric database that maps FR2 cells to geo locations. If a current geolocation of the UE has one or more FR2 cells tagged, the UE may increase the number of measurement opportunities used to measure SSB from the identified FR2 cells.

After determining the NR addition measurement decision 310 based on one or more of the signal quality based feedback 312, the sensor inputs 314, the motion state 316, and the geo location 318, instructions are provided to a measurement scheduler 320 corresponding to either a measurement request for the next SSB or a measurement suppression of the next SSB. If the measurement scheduler 320 receives instructions for a measurement request to measure the next SSB, the measurement scheduler 320 schedules the SSB measurement for the next SSB measurement opportunity and measurement results 322 are reported to the base station and provided in a feedback loop as an input to the signal quality based feedback 312. If, however, the measurement scheduler 320 receives instructions for a measurement suppression for the next SSB, the UE skips the SSB measurement for the next SSB measurement opportunity.

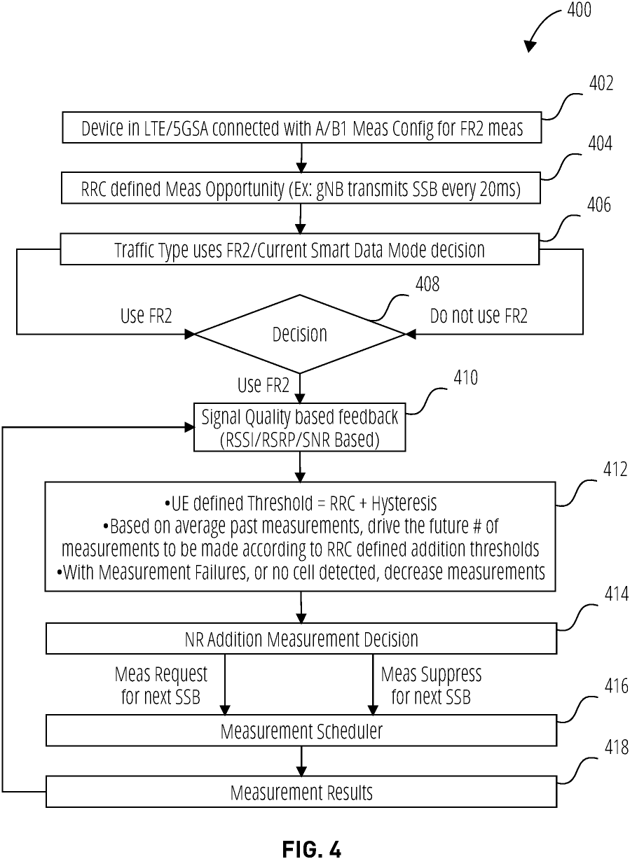

FIG. 4 is a flowchart of a method 400 for NR addition measurement according to one embodiment. In a block 402, a device (e.g., UE) is in LTE and/or 5G standalone (SA) connected mode with an A threshold (for LTE addition) and/or B1 threshold (for NR addition) measurement configuration for FR2 measurement and reporting. In a block 404, the UE receives an RRC defined measurement opportunity (e.g., corresponding to a gNB transmitting SSB every 20 ms). In a block 406, the UE determines whether the current traffic type uses FR2. In addition, or in another embodiment, the UE determines whether a current smart data mode decision uses FR2. In a decision block 408, if FR2 is not to be used, the method 400 ends or returns to the block 402. In the decision block 408, if FR2 is to be used, the UE determines to proceed with the method 400.

In a block 410, the UE processes signal quality based feedback, which may be based on RSSI, RSRP, and/or SNR measurements. In a block 412, the UE determines a UE defined addition threshold that includes an RRC threshold value and a hysteresis value. The hysteresis value may be determined by the UE based on average past measurements or may be provided to the UE via RRC signaling. Based on average past measurements, the UE drives or determines the future number of measurements to be made according to RRC defined addition thresholds. In certain embodiments, when there is a measurement failure, or when no cell is detected, the UE decreases the number of SSB measurements over a period of time (e.g., skips one or more of the measurement opportunities).

In a block 414, the UE performs an NR addition measurement decision based on the signal quality based feedback. Based on the result of the NR addition measurement decision, the UE sends, to a measurement scheduler, a measurement request message for a next SSB or a measurement suppress message for the next SSB.

In a block 416, the measurement scheduler receives the measurement request message for the next SSB, the measurement scheduler schedules an SSB measurement for a next SSB measurement opportunity. If, however, the measurement scheduler receives the measurement suppress message for the next SSB, the measurement scheduler does not schedule an SSB measurement and the UE skips the next SSB measurement opportunity.

In a block 418, the UE reports measurement results to the base station. The UE also provides the measurement results in a feedback loop as an input to the block 410 for signal quality based feedback.

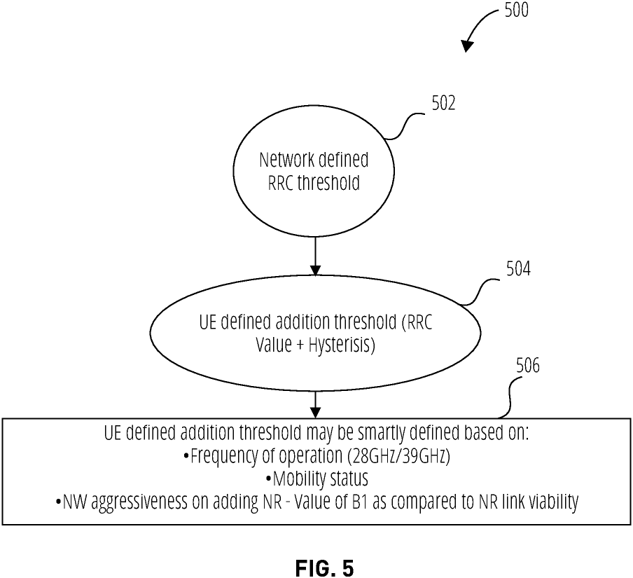

FIG. 5 is a flowchart of a method 500 for determining a UE defined addition threshold for NR addition according to one embodiment. In a block 502, the method 500 includes receiving, at the UE from a base station, a network defined RRC threshold value for NR addition. At a block 504, the method 500 includes determining the UE defined addition threshold value as being the sum of the network defined RRC threshold value and a hysteresis value. The hysteresis value may be determined by the UE based on the average past measurements or may be provided to the UE from the base station via RRC signaling.

In certain embodiments of the method 500, as shown in block 506, the UE defined addition threshold may be smartly defined based on one or more parameters such as frequency of operation, mobility status, and/or network (NW) aggressiveness or preference for adding an NR cell in FR2.

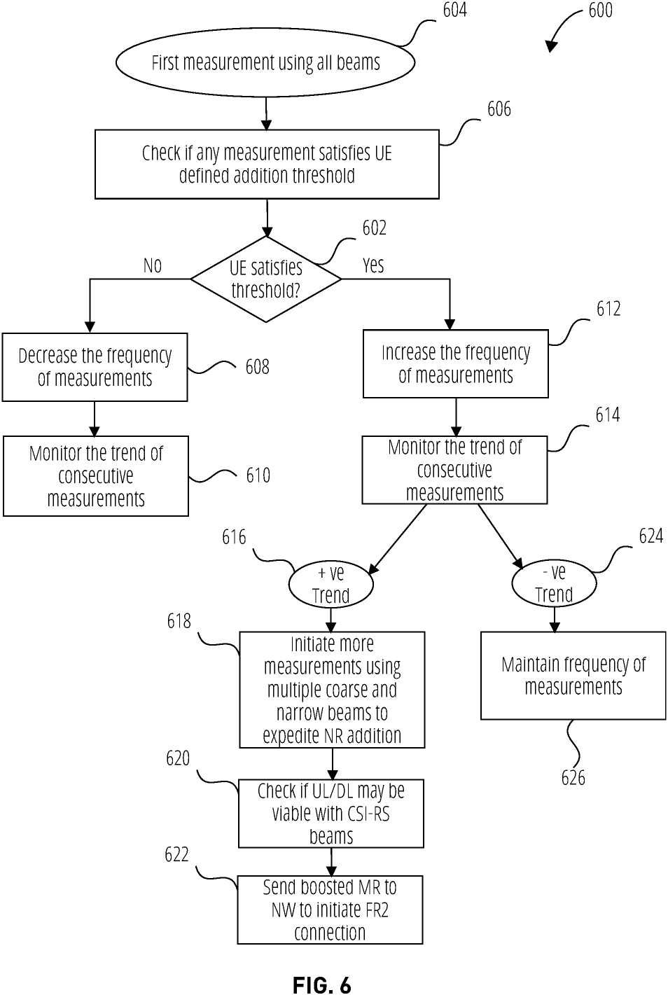

FIG. 6 is a flowchart of a method 600 for NR addition measurement according to one embodiment. In a block 604, the method 600 includes performing a first measurement using all beams. For example, the UE may measure SSB from a gNB at each measurement opportunity. In a block 606, the method 600 includes checking to determine whether any measurement satisfies a UE defined addition threshold. At decision block 602, if no measurement satisfies the UE defined addition threshold, then the method 600 proceeds to block 608 and decreases the frequency of the measurements. For example, the UE may perform SSB measurements less often when it is outside the area 114 shown in FIG. 1. In block 610, the method 600 includes monitoring the trend of consecutive measurements at the reduced measurement frequency (e.g., until a measurement satisfies the UE defined addition threshold).

If at the decision block 602, however, an SSB measurement satisfies the UE defined addition threshold, then the method 600 proceeds to block 612 and increases the frequency of measurements. For example, the UE may perform SSB measurements more often when it is within the area 114 shown in FIG. 1. In block 614, the method 600 includes monitoring the trend of consecutive measurements. If the trend includes measuring increasing power (+ve Trend), as in block 616, then in block 618 the method 600 includes initiating more measurements using multiple coarse and narrow beams to expedite NR addition. In certain embodiments, in block 620 the method 600 further includes checking whether UL and/or DL may be viable with CSI-RS beams. In block 622, the method includes sending a boosted measurement report (MR) to the NW to initiate FR2 connection. The boosted MR refers to sending MR before satisfying the 5G entry criteria by accounting for future gain when the UE actually starts communicating data using the cell. For example, if the UE determines that it could have additional beamforming gain or projects the gain once it latches on to the cell, the UE may pre-emptively send the MR even before it satisfies the 5G entry criteria with the current UE gain. Once the MR is sent, the UE then increases the gain to achieve the link budget. If the trend includes measuring decreasing power (-ve Trend), as in block 624, then in block 626 the method 600 includes maintaining the frequency of the measurements.

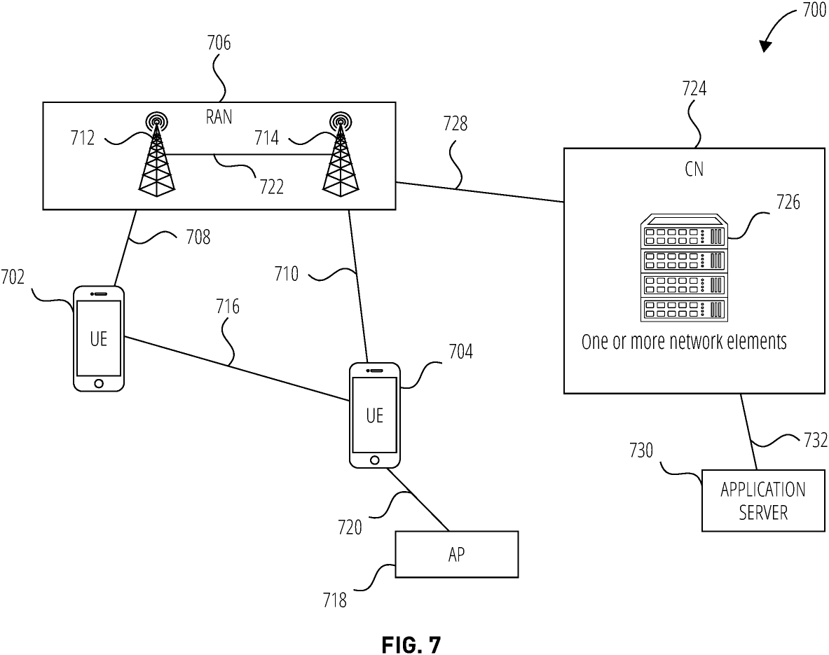

FIG. 7 illustrates an example architecture of a wireless communication system 700, according to embodiments disclosed herein. The following description is provided for an example wireless communication system 700 that operates in conjunction with the LTE system standards and/or 5G or NR system standards as provided by 3GPP technical specifications.

As shown by FIG. 7, the wireless communication system 700 includes UE 702 and UE 704 (although any number of UEs may be used). In this example, the UE 702 and the UE 704 are illustrated as smartphones (e.g., handheld touchscreen mobile computing devices connectable to one or more cellular networks), but may also comprise any mobile or non-mobile computing device configured for wireless communication.

The UE 702 and UE 704 may be configured to communicatively couple with a RAN 706. In embodiments, the RAN 706 may be NG-RAN, E-UTRAN, etc. The UE 702 and UE 704 utilize connections (or channels) (shown as connection 708 and connection 710, respectively) with the RAN 706, each of which comprises a physical communications interface. The RAN 706 can include one or more base stations, such as base station 712 and base station 714, that enable the connection 708 and connection 710.

In this example, the connection 708 and connection 710 are air interfaces to enable such communicative coupling, and may be consistent with RAT(s) used by the RAN 706, such as, for example, an LTE and/or NR.

In some embodiments, the UE 702 and UE 704 may also directly exchange communication data via a sidelink interface 716. The UE 704 is shown to be configured to access an access point (shown as AP 718) via connection 720. By way of example, the connection 720 can comprise a local wireless connection, such as a connection consistent with any IEEE 802.11 protocol, wherein the AP 718 may comprise a Wi-FiⓇ router. In this example, the AP 718 may be connected to another network (for example, the Internet) without going through a CN 724.

In embodiments, the UE 702 and UE 704 can be configured to communicate using orthogonal frequency division multiplexing (OFDM) communication signals with each other or with the base station 712 and/or the base station 714 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 712 or base station 714 may be implemented as one or more software entities running on server computers as part of a virtual network. In addition, or in other embodiments, the base station 712 or base station 714 may be configured to communicate with one another via interface 722. In embodiments where the wireless communication system 700 is an LTE system (e.g., when the CN 724 is an EPC), the interface 722 may be an X2 interface. The X2 interface may be defined between two or more base stations (e.g., two or more eNBs and the like) that connect to an EPC, and/or between two eNBs connecting to the EPC. In embodiments where the wireless communication system 700 is an NR system (e.g., when CN 724 is a 5GC), the interface 722 may be an Xn interface. The Xn interface is defined between two or more base stations (e.g., two or more gNBs and the like) that connect to 5GC, between a base station 712 (e.g., a gNB) connecting to 5GC and an eNB, and/or between two eNBs connecting to 5GC (e.g., CN 724).

The RAN 706 is shown to be communicatively coupled to the CN 724. The CN 724 may comprise one or more network elements 726, which are configured to offer various data and telecommunications services to customers/subscribers (e.g., users of UE 702 and UE 704) who are connected to the CN 724 via the RAN 706. The components of the CN 724 may be implemented in one physical device or separate physical devices including components to read and execute instructions from a machine-readable or computer-readable medium (e.g., a non-transitory machine-readable storage medium).

In embodiments, the CN 724 may be an EPC, and the RAN 706 may be connected with the CN 724 via an S1 interface 728. In embodiments, the S1 interface 728 may be split into two parts, an S1 user plane (S1-U) interface, which carries traffic data between the base station 712 or base station 714 and a serving gateway (S-GW), and the S1-MME interface, which is a signaling interface between the base station 712 or base station 714 and mobility management entities (MMEs).

In embodiments, the CN 724 may be a 5GC, and the RAN 706 may be connected with the CN 724 via an NG interface 728. In embodiments, the NG interface 728 may be split into two parts, an NG user plane (NG-U) interface, which carries traffic data between the base station 712 or base station 714 and a user plane function (UPF), and the S1 control plane (NG-C) interface, which is a signaling interface between the base station 712 or base station 714 and access and mobility management functions (AMFs).

Generally, an application server 730 may be an element offering applications that use internet protocol (IP) bearer resources with the CN 724 (e.g., packet switched data services). The application server 730 can also be configured to support one or more communication services (e.g., VoIP sessions, group communication sessions, etc.) for the UE 702 and UE 704 via the CN 724. The application server 730 may communicate with the CN 724 through an IP communications interface 732.

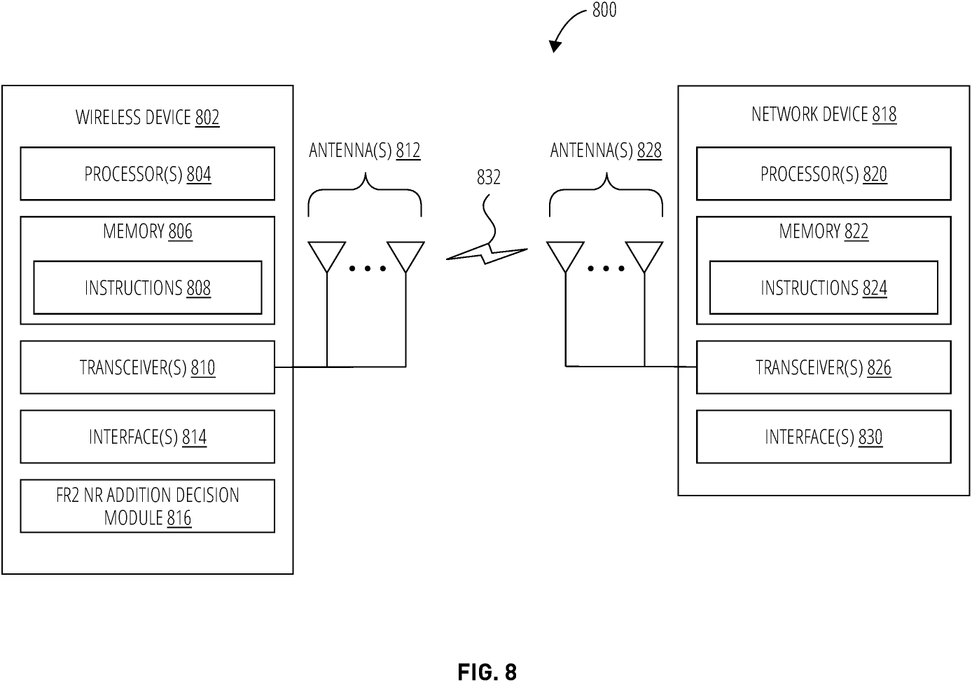

FIG. 8 illustrates a system 800 for performing signaling 832 between a wireless device 802 and a network device 818, according to embodiments disclosed herein. The system 800 may be a portion of a wireless communications system as herein described. The wireless device 802 may be, for example, a UE of a wireless communication system. The network device 818 may be, for example, a base station (e.g., an eNB or a gNB) of a wireless communication system.

The wireless device 802 may include one or more processor(s) 804. The processor(s) 804 may execute instructions such that various operations of the wireless device 802 are performed, as described herein. The processor(s) 804 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 802 may include a memory 806. The memory 806 may be a non-transitory computer-readable storage medium that stores instructions 808 (which may include, for example, the instructions being executed by the processor(s) 804). The instructions 808 may also be referred to as program code or a computer program. The memory 806 may also store data used by, and results computed by, the processor(s) 804.

The wireless device 802 may include one or more transceiver(s) 810 that may include radio frequency (RF) transmitter and/or receiver circuitry that use the antenna(s) 812 of the wireless device 802 to facilitate signaling (e.g., the signaling 832) to and/or from the wireless device 802 with other devices (e.g., the network device 818) according to corresponding RATs.

The wireless device 802 may include one or more antenna(s) 812 (e.g., one, two, four, or more). For embodiments with multiple antenna(s) 812, the wireless device 802 may leverage the spatial diversity of such multiple antenna(s) 812 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 802 may be accomplished according to precoding (or digital beamforming) that is applied at the wireless device 802 that multiplexes the data streams across the antenna(s) 812 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 802 may implement analog beamforming techniques, whereby phases of the signals sent by the antenna(s) 812 are relatively adjusted such that the (joint) transmission of the antenna(s) 812 can be directed (this is sometimes referred to as beam steering).

The wireless device 802 may include one or more interface(s) 814. The interface(s) 814 may be used to provide input to or output from the wireless device 802. For example, a wireless device 802 that is a UE may include interface(s) 814 such as microphones, speakers, a touchscreen, buttons, and the like in order to allow for input and/or output to the UE by a user of the UE. Other interfaces of such a UE may be made up of made up of transmitters, receivers, and other circuitry (e.g., other than the transceiver(s) 810/antenna(s) 812 already described) that allow for communication between the UE and other devices and may operate according to known protocols (e.g., Wi-Fi®, BluetoothⓇ, and the like).

The wireless device 802 may include a FR2 NR addition decision module 816. The FR2 NR addition decision module 816 may be implemented via hardware, software, or combinations thereof. For example, the FR2 NR addition decision module 816 may be implemented as a processor, circuit, and/or instructions 808 stored in the memory 806 and executed by the processor(s) 804. In some examples, the FR2 NR addition decision module 816 may be integrated within the processor(s) 804 and/or the transceiver(s) 810. For example, the FR2 NR addition decision module 816 may be implemented by a combination of software components (e.g., executed by a DSP or a general processor) and hardware components (e.g., logic gates and circuitry) within the processor(s) 804 or the transceiver(s) 810.

The FR2 NR addition decision module 816 may be used for various aspects of the present disclosure, for example, aspects of FIGS. 1-6.

The network device 818 may include one or more processor(s) 820. The processor(s) 820 may execute instructions such that various operations of the network device 818 are performed, as described herein. The processor(s) 820 may include one or more baseband processors implemented using, for example, a CPU, a DSP, an ASIC, a controller, an FPGA device, another hardware device, a firmware device, or any combination thereof configured to perform the operations described herein.

The network device 818 may include a memory 822. The memory 822 may be a non-transitory computer-readable storage medium that stores instructions 824 (which may include, for example, the instructions being executed by the processor(s) 820). The instructions 824 may also be referred to as program code or a computer program. The memory 822 may also store data used by, and results computed by, the processor(s) 820.

The network device 818 may include one or more transceiver(s) 826 that may include RF transmitter and/or receiver circuitry that use the antenna(s) 828 of the network device 818 to facilitate signaling (e.g., the signaling 832) to and/or from the network device 818 with other devices (e.g., the wireless device 802) according to corresponding RATs.

The network device 818 may include one or more antenna(s) 828 (e.g., one, two, four, or more). In embodiments having multiple antenna(s) 828, the network device 818 may perform MIMO, digital beamforming, analog beamforming, beam steering, etc., as has been described.

The network device 818 may include one or more interface(s) 830. The interface(s) 830 may be used to provide input to or output from the network device 818. For example, a network device 818 that is a base station may include interface(s) 830 made up of transmitters, receivers, and other circuitry (e.g., other than the transceiver(s) 826/antenna(s) 828 already described) that enables the base station to communicate with other equipment in a core network, and/or that enables the base station to communicate with external networks, computers, databases, and the like for purposes of operations, administration, and maintenance of the base station or other equipment operably connected thereto.

Embodiments contemplated herein include an apparatus comprising means to perform one or more elements of the processes or methods shown in FIG. 2 to FIG. 6. This apparatus may be, for example, an apparatus of a UE (such as a wireless device 802 that is a UE, as described herein).

Embodiments contemplated herein include one or more non-transitory computer-readable media comprising instructions to cause an electronic device, upon execution of the instructions by one or more processors of the electronic device, to perform one or more elements of the processes and methods described herein. This non-transitory computer-readable media may be, for example, a memory of a UE (such as a memory 806 of a wireless device 802 that is a UE, as described herein).

Embodiments contemplated herein include an apparatus comprising logic, modules, or circuitry to perform one or more elements of the processes and methods described herein. This apparatus may be, for example, an apparatus of a UE (such as a wireless device 802 that is a UE, as described herein).

Embodiments contemplated herein include an apparatus comprising: one or more processors and one or more computer-readable media comprising instructions that, when executed by the one or more processors, cause the one or more processors to perform one or more elements of the processes and methods described herein. This apparatus may be, for example, an apparatus of a UE (such as a wireless device 802 that is a UE, as described herein).

Embodiments contemplated herein include a signal as described in or related to one or more elements of the processes and methods described herein.

Embodiments contemplated herein include a computer program or computer program product comprising instructions, wherein execution of the program by a processor is to cause the processor to carry out one or more elements of the processes and methods described herein. The processor may be a processor of a UE (such as a processor(s) 804 of a wireless device 802 that is a UE, as described herein). These instructions may be, for example, located in the processor and/or on a memory of the UE (such as a memory 806 of a wireless device 802 that is a UE, as described herein).

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A method for a user equipment (UE) connected to a network using a first frequency range (FR1) and configured for millimeter wave (mmWave) beam measurement to communicate using a second frequency range (FR2), the method comprising:
receiving, from a base station, measurement configuration information including an indication of measurement opportunities;
determining that a current data traffic type is associated with mmWave communication;
in response to the current data traffic type being associated with the mmWave communication, performing an FR2 cell addition measurement decision, wherein the FR2 cell addition measurement decision is based on one or more of:
signal quality feedback;
sensor input;
UE motion state; and
geographic (geo) location information associated with FR2 cell information; and
based on the FR2 cell addition measurement decision, suppressing or selecting a next measurement opportunity of the measurement opportunities for measuring one or more mmWave signals.

2. The method of claim 1, further comprising, when the FR2 cell addition measurement decision is based on the signal quality feedback:
processing synchronization signal block (SSB) based measurements to determine measurement values comprising a received signal strength indicator (RSSI), a reference signal received power (RSRP), or a signal-to-noise ratio (SNR); and
based on an average of the measurement values, determine a future number of SSB based measurements over a period of time.

3. The method of claim 1, further comprising, when the FR2 cell addition measurement decision is based on the signal quality feedback:
receiving a radio resource control (RRC) threshold value for addition of an FR2 cell; and
determining a UE defined addition threshold comprising the RRC threshold value and a hysteresis value.

4. The method of claim 3, further comprising:
measuring a synchronization signal block (SSB) received from the FR2 cell to determine a measurement value;
when the measurement value is greater than the UE defined addition threshold, increasing a periodicity of SSB measurements; and
when the measurement value is less than the UE defined addition threshold, decreasing the periodicity of SSB measurements.

5. The method of claim 4, further comprising, when a measurement failure occurs or the FR2 cell is not detected, decreasing the periodicity of SSB measurements.

6. The method of claim 3, further comprising:
measuring a plurality of beams from the FR2 cell;
determining whether at least one measurement value of the plurality of beams satisfies the UE defined addition threshold;
if the at least one measurement value of the plurality of beams does not satisfy the UE defined addition threshold, decreasing a frequency of measurements; and
if the at least one measurement value of the plurality of beams satisfies the UE defined addition threshold, increasing the frequency of measurements and monitoring a trend of consecutive measurements.

7. The method of claim 6, further comprising, when the trend of consecutive measurements increases in value:
initiating more measurements using multiple coarse and narrow beams; and
in response to determining that at least one of uplink and downlink is viable with channel state information reference signal (CSI-RS) beams, sending a boosted measurement report (MR) to the network to initiate a connection with the FR2 cell.

8. The method of claim 6, further comprising, when the trend of consecutive measurements decreases in value, maintaining the frequency of measurements.

9. The method of claim 1, further comprising, when the FR2 cell addition measurement decision is based on the sensor input:
determining, based on a signal received from a wireless local area network (WLAN), that FR2 coverage is unavailable for an indoor UE location;
in response to determining that the FR2 coverage is unavailable for the indoor UE location, not initiating further measurements; and
in response to determining that the UE has transitioned from the indoor UE location to an outdoor UE location, resuming a search for an FR2 cell.

10. The method of claim 1, further comprising, when the FR2 cell addition measurement decision is based on the motion state:
determining whether a current mobility state of the UE is stationary or mobile; and
when the current mobility state of the UE is stationary, decreasing a periodicity of FR2 cell measurements as compared to when the current mobility state of the UE is mobile.

11. The method of claim 10, further comprising, when the current mobility state of the UE is mobile, decreasing the periodicity of the FR2 cell measurements as a speed of the UE decreases.

12. The method of claim 1, further comprising, when the FR2 cell addition measurement decision is based on geo location information:
checking a list or database to determine that a current geo location of the UE is tagged with one or more FR2 cells; and
in response to the current geo location of the UE being tagged with the one or more FR2 cells, increasing a periodicity of FR2 cell measurements.

13. A user equipment (UE) comprising:
a processor; and
a memory storing instructions that, when executed by the processor, configure the UE to:
receive, from a base station, measurement configuration information including an indication of measurement opportunities;
determine that a current data traffic type is associated with mmWave communication;
in response to the current data traffic type being associated with the mmWave communication, perform an FR2 cell addition measurement decision, wherein the FR2 cell addition measurement decision is based on one or more of:
signal quality feedback;
sensor input;
UE motion state; and
geographic (geo) location information associated with FR2 cell information; and
based on the FR2 cell addition measurement decision, suppress or select a next measurement opportunity of the measurement opportunities for measuring one or more mmWave signals.

14. The UE of claim 13, wherein the instructions further configure the UE to, when the FR2 cell addition measurement decision is based on the signal quality feedback:
process synchronization signal block (SSB) based measurements to determine measurement values comprising a received signal strength indicator (RSSI), a reference signal received power (RSRP), or a signal-to-noise ratio (SNR); and
based on an average of the measurement values, determine a future number of SSB based measurements over a period of time.

15. The UE of claim 13, wherein the instructions further configure the UE to, when the FR2 cell addition measurement decision is based on the signal quality feedback:
receive a radio resource control (RRC) threshold value for addition of an FR2 cell; and
determine a UE defined addition threshold comprising the RRC threshold value and a hysteresis value.

16. The UE of claim 15, wherein the instructions further configure the UE to:
measure a synchronization signal block (SSB) received from the FR2 cell to determine a measurement value;
when the measurement value is greater than the UE defined addition threshold, increase a periodicity of SSB measurements; and
when the measurement value is less than the UE defined addition threshold, decrease the periodicity of SSB measurements.

17. The UE of claim 16, wherein the instructions further configure the UE to, when a measurement failure occurs or the FR2 cell is not detected, decrease the periodicity of SSB measurements.

18. The UE of claim 15, wherein the instructions further configure the UE to:
measure a plurality of beams from the FR2 cell;
determine whether at least one measurement value of the plurality of beams satisfies the UE defined addition threshold;
if the at least one measurement value of the plurality of beams does not satisfy the UE defined addition threshold, decrease a frequency of measurements; and
if the at least one measurement value of the plurality of beams satisfies the UE defined addition threshold, increase the frequency of measurements and monitoring a trend of consecutive measurements.

19. The UE of claim 18, wherein the instructions further configure the UE to, when the trend of consecutive measurements increases in value:
initiate more measurements using multiple coarse and narrow beams; and
in response to determining that at least one of uplink and downlink is viable with channel state information reference signal (CSI-RS) beams, send a boosted measurement report (MR) to initiate a connection with the FR2 cell.

20. The UE of claim 18, wherein the instructions further configure the UE to, when the trend of consecutive measurements decreases in value, maintain the frequency of measurements.
